(19) United States
(12) Patent Application Publication
(10) Pub. No.: US 2009/0081111 A1
(43) Pub. Date: Mar. 26, 2009

(54) Vanadia-Titania Aerogel Catalysts, Preparing Method of the Same, and Oxidative Destruction of Chlorinated Aromatic Compounds Using the Same

(75) Inventors: Dong Jin Suh, Seoul (KR); Tae Jin Park, Seoul (KR); Young Hyun Yoon, Seoul (KR); Jin Soon Choi, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: Korea Institute of Science and Technology, Seoul (KR)

(21) Appl. No.: 11/720,724

(22) PCT Filed: Nov. 29, 2005
(86) PCT No.: PCT/KR2005/003621

§ 371 Date: Jun. 23, 2008

(30) Foreign Application Priority Data
Dec. 2, 2004 (KR) 10-2004-0100192

(51) Int. Cl. C01B 31/18; B01J 23/22; B01J 23/34; B01J 27/02; B01J 27/053; C01B 31/20

(52) U.S. Cl. 423/418.2; 502/350; 502/324; 502/216; 502/217; 423/437.1

(57) ABSTRACT

Disclosed are a vanadia-titania aerogel catalyst having high specific surface area and porosity, a method of preparing the same and a method of completely oxidatively-decomposing a chlorinated aromatic compound using the catalyst under air condition. The vanadia-titania aerogel catalyst of the invention is an aerogel form having many porosities and a high specific surface area obtained by performing a supercritical drying of vanadia-titania wet gel, which is prepared by a sol-gel method, with carbon dioxide and then firing the dried vanadia-titania, with a micro porosity structure being maintained, consists of vanadia and titania wherein a content of the vanadia is 1˜15 wt % of an overall catalyst weight. In addition, according to the invention, the vanadia-titania aerogel catalyst may further comprise a manganese oxide of 1-5 wt % or a sulfur component of 0.0001-1 wt %. Since the vanadia-titania aerogle catalyst of the invention has the very high conversion rate and selectivity for the complete oxidation reaction of the chlorinated aromatic compound and is very thermally stable, it can be usefully used in the oxidation reaction having a high heating value capable of generating local heat spots.

### TECHNICAL FIELD

The present invention relates to a vanadia-titania aerogel catalyst having high specific surface area and porosity, a method of preparing the same and a method of completely oxidatively-decomposing a chlorinated aromatic compound under air conditions using the catalyst.

### BACKGROUND ART

Since a chlorinated aromatic compound exhibits toxicity itself and can serve as a chemical generation precursor of polychlorinated biphenyl, polychlorinated dibenzo furan, polychlorinated dibenzo dioxin or the like, it has been taken many interests. A catalytic control method of a chlorinated organic material is divided into a hydrodechlorination reaction and an oxidation reaction. There have been performed researches on metal oxide catalysts of noble metals such as platinum, rhodium and palladium and the like, zero valence metals such as nickel, iron and the like, and a variety of transition metals.

For example, a Korean Patent Application No. 10-2001-0001198 discloses a hydrodechlorination reaction using a noble metal-supported catalyst. However, in this case, it has limitations such that the catalyst costs too much and an activity of the noble metal is decreased due to chlorine poisoning. Many catalysts of the metal oxides have the poisoning problem. For example, it may be possible that chromium, which is much used for a decomposition reaction of a chlorinated material, forms CrO₂Cl₂ (boiling point: 117° C.) to constraint a life span or use of the catalyst.

To the contrary, in case of a vanadium oxide, an activity thereof is not decreased even during the reaction for 100 hours or more and a volatile chlorinated material is not formed, so that the vanadium oxide has a high possibility of an industrial applicability [Sundaram Krishnamoorthy, Julia P. Baker, and Michael D. Amiridis, Catal., Today 40 (1998) 39]. In fact, the vanadium oxide is widely used for the oxidation reaction of the chlorinated organic material [Korean Patent Application No. 10-1998-0055435]. In addition, since the vanadium oxide has a high activity for the oxidation reaction, it maintains 95% or more selectivity of a carbon oxide.

In the mean time, a catalytic reaction generally occurs on a surface of the catalyst. Accordingly, the larger a specific surface area and the less a resistance to diffusion between porosities of the catalyst, the higher a reactivity. An aerogel type catalyst has all the above properties and high thermal stability, uniformity and degree of dispersion, so that it is used as a catalyst in a variety of reactions [Dong Jin Suh, Tae-Jin Park, Seo-Ho Lee, and Kyung-Lim Kim, J. Non-crytal. Sol, 285 (2001) 309, and U.S. Pat. No. 6,271,170].

A non-uniform catalitic oxidation is a very useful industrial process and has been mainly used for a partial oxidation process for obtaining a chemical product. However, as it has been increased environment-friendly needs, it has been concerned about a complete oxidation of a low concentration-toxic halogen compound as well as a volatile organic compound.

### DISCLOSURE

### Technical Problem

An object of the invention is to provide a vanadia-titania aerogel catalyst of low cost and high efficiency having high specific surface area and porosity properties and high resistance to chlorine poisoning and physical stability obtained by performing a supercritical drying of vanadia-titania wet gel, which is prepared by a sol-gel method, using carbon dioxide and then firing the dried vanadia-titania gel, and to provide a method of preparing the catalyst.

Another object of the invention is to provide an environment-friendly oxidative decomposition method of a chlorinated aromatic compound performing an oxidation reaction of the chlorinated aromatic compound using the vanadia-titania aerogel catalyst under air atmosphere to remove a by-product of the chlorinated material having a high toxicity, thereby improving a selectivity of a carbon oxide.

### Technical Solution

In order to achieve the above objects, there is provided a vanadia-titania aerogel catalyst having an aerogel form dried by a supercritical drying method with a micro porosity structure being maintained and having many porosities and a wide specific surface area and consisting of vanadia and titania, a content of the vanadia being 1˜15 wt % of an overall catalyst weight. When the content of the vanadia is more than 15 wt %, a structure of the titania is changed into a rutile form, so that an activity of the catalyst is rapidly decreased.

According to an embodiment of the invention, the catalyst may further contain a manganese oxide of 1˜5 wt %. When the content of the manganese oxide is more than 5 wt % of the overall catalyst weight, the specific surface area is rapidly decreased and the structure of the titania is changed.

According to an embodiment of the invention, the catalyst may further contain a sulfur component of 0.0001˜1 wt %. When the sulfur component is added in a sulfate form, it is formed polyvanadate having an excellent oxidation reaction activity. If the content of the sulfur component is more than 1 wt % of the overall catalyst weight, the catalyst activity is lowered due to formation of bulk vanadia.

In order to achieve the above objects, according to another aspect of the invention, there is provided a method of preparing a vanadia-titania aerogel catalyst, the method comprising a first step of adding an acid catalyst to a solution of alkoxide or non-alkoxide inorganic gel raw material which is a precursor of a vanadium oxide and a titanium oxide and maintaining a temperature to be constant, thereby synthesizing gel; a second step of maturing the gel prepared in the first step at constant temperature; a third step of solvent-exchanging the gel matured in the second step using carbon dioxides and then drying it via a supercritical process; and a fourth step of removing an organic material of the aerogel dried in the third step under inert atmosphere and then heat-treating the aerogel under air or oxygen atmosphere.

According to an embodiment of the invention, when the inorganic gel raw material in the first step is non-alkoxide, one or more epoxides selected from a group consisting of ethylene oxide, propylene oxide and butylene oxide may be together used.

According to an embodiment of the invention, the acid catalyst in the first step may be at least one selected from a group consisting of hydrochloric acid, nitric acid, acetic acid and oxalic acid.

According to an embodiment of the invention, at least one of a precursor of a manganese oxide and a sulfur component may be further added to the inorganic gel raw material in the first step.

According to an embodiment of the invention, the precursor of the manganese oxide may be manganese nitrate, manganese acetate or manganese hydrochloride and the sulfur component may be sulfuric acid or sulfate.

According to another aspect of the invention, there is provided an oxidative decomposition method of a chlorinated aromatic compound wherein the chlorinated aromatic compound is subject to an oxidation reaction using the vanadia-titania aerogel catalyst.

### ADVANTAGEOUS EFFECTS

The vanadia-titania aerogle catalyst of the invention has the very high conversion rate and selectivity degree for the complete oxidation reaction of the chlorinated aromatic compound and is very thermally stable, it can be usefully used in the oxidation reaction having a high heating value capable of generating local heat spots. In particular, most of the chlorinated materials are generally incinerated. Accordingly, when the vanadia-titania aerogel catalyst of the invention is provided to a rear end of an incinerator, it is possible to maintain a proper temperature at which the catalyst can exhibit an activity thereof, so that it is efficient in cost reduction.

The vanadia-titania aerogel catalyst of the invention is not limited to the oxidation reaction of the chlorinated aromatic compound and can be also usefully used for a de-NOx reaction or ammoxidation reaction.

### DESCRIPTION OF DRAWINGS

FIGS. 1 and 2 are electron microscope (Transmission Electron Microscope; TEM) photographs of 4 wt % and 10 wt % vanadia-titania aerogel catalysts according to embodiments of the invention, respectively;

FIG. 3 shows a Raman analysis result of 5 wt % and 10 wt % vanadia-titania aerogel catalysts according to embodiments of the invention; and

FIG. 4 is a graph comparing a conversion rate of a chlorinated material and a yield of a carbon oxide obtained by oxidation-reacting a chlorinated aromatic compound using a vanadia-titania aerogel catalyst according to an embodiment of the invention.

### BEST MODE

A method of preparing a vanadia-titania aerogel catalyst according to the invention is as follows.

In a first step, wet gel is formed using a sol-gel method. Alkoxide or non-alkoxide is used as a precursor of a vanadium oxide and a titanium oxide.

Ethanol or methanol is used as a solvent and a temperature is maintained to be constant. An acid catalyst such as hydrochloric acid, nitric acid, acetic acid, oxalic acid and the like is added for a structural characteristic of the gel and water of a stoichiometrical ratio is added for the gelling. In case of the non-alkoxide, epoxide such as ethylene oxide, propylene oxide and butylene oxide is used for the gelling. In some cases, a precursor of a manganese oxide such as manganese nitrate, manganese acetate and manganese hydrochloride and a sulfur component such as sulfuric acid or sulfate may be added.

In a second step, the gel is matured. The gel is stabilized for a maturation period of 1˜30 days at a room temperature under sealed conditions. In some cases, a refrigeration maturation (4° C.) or high temperature maturation (40˜60° C.) may be performed.

In a third step, it is obtained aerogel by supercritical-drying the gel using carbon dioxides. In the drying process, an exchange process of liquid carbon dioxide and the solvent, a pressure-increasing process, a temperature-increasing process, a pressure-reducing process and a temperature-reducing process are carried out. The carbon dioxide between the temperature-increasing process and the pressure-reducing process is maintained under supercritical conditions with a temperature of 40˜90° C. and a pressure of 100˜300 atm. Any supercritical conditions are possible if the conditions are above a critical temperature of 31.1° C. and a critical pressure of 72.8 atm of the carbon dioxide. Preferably, it is maintained conditions of 50˜70° C. and 150˜200 atm. A specific surface area of the aerogel after the drying is about 600˜700 m²/g.

In a fourth step, the dried aerogel is heat-treated. A 300˜400° C. heat treatment is carried out under helium or argon atmosphere so to remove an organic material and a 500˜600° C. heat treatment is performed under air or oxygen atmosphere. The specific surface area of the aerogel after the heat treatment is 50˜200 m²/g.

A chlorinated aromatic compound such as 1,2-dichlorobenzene is subject to an oxidation reaction using the vanadia-titania aerogel catalyst of the invention prepared as described above. The catalyst is filled in a fixed-bed reactor and then oxygen 20%, nitrogen 80% and 1,2-dichlorobenzene 1,000 ppm are passed to. A spatial speed of the gas in the reaction is 5,000˜60,000 h⁻¹ and a reaction temperature is 150˜600° C. At this time, a preferred temperature is 350° C.

### MODE FOR INVENTION

Hereinafter, the invention will be more specifically described with reference to preferred embodiments. However, it should be noted that the embodiments are provided only to illustrate the invention and the invention is not limited thereto.

### Example 1

### Preparation of Vanadia-Titania Aerogel Catalyst (Alkoxide was Used)

A solution was prepared so that a mole ratio of titanium (IV) butoxide (Ti[O(CH₂)₃CH₃]₄), water, nitric acid and ethanol was 1:4:0.1:30. To the solution was added vanadium triisopropoxide oxide ([(CH₃)₂CHO]₃VO) to be 2 wt %, 3 wt %, 4, wt %, 5 wt % and 10 wt %, respectively. When gel was formed through a stirring for a predetermined time, the stirring was stopped and then the gel was matured at a room temperature. The gel after the three days of maturation was put in a high-pressure reactor and liquid carbon dioxide was introduced to be exchanged with the ethanol solvent. It was allowed an exchange time of four hours for sufficient solvent exchange and then it was maintained carbon dioxide supercritical conditions of 60° C. and 200 atm through processes of increasing temperature and pressure. The carbon dioxide was allowed to flow so as to remove even a very small amount of the solvent with the supercritical conditions being maintained. After about 6 hours, it was obtained aerogel dried through the processes of reducing pressure and temperature. The aerogel obtained through the supercritical drying process was subject to heat treatment so as to have a metal oxide structure. The aerogel was subject to helium treatment (300° C., 2 hours) so as to remove an organic material and treated under oxygen atmosphere (500° C., 2 hours) so as to obtain an oxide. As a result, it was finally obtained a vanadia-titania aerogel catalyst.

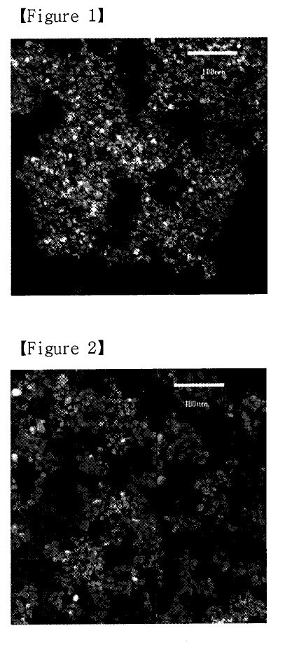

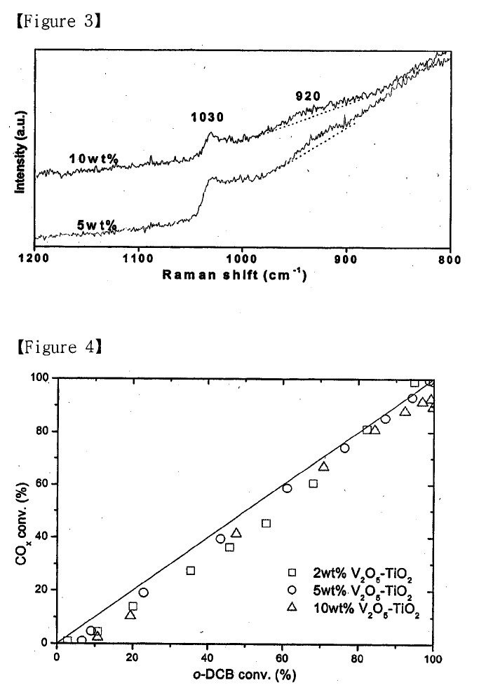

FIGS. 1 and 2 are electron microscope (TEM) photographs of 4 wt % and 10 wt % vanadia-titania aerogel catalysts according to embodiments of the invention, respectively. From the TEM photographs of FIGS. 1 and 2, it can be seen that they exhibit a uniform particle distribution of about 10 nm. FIG. 3 shows a Raman analysis result of 5 wt % and 10 wt % vanadia-titania aerogel catalysts according to embodiments of the invention. From the Raman analysis of FIG. 3, it is possible to identify a structure of vanadia formed on a titania surface. From FIG. 3, it can be seen that polyvanadate was formed at 920 cm⁻¹ and monovanadate was formed at 1030 cm⁻¹.

### Experimental Example 1

### Oxidation Reaction of Chlorinated Aromatic Compound

It was measured a conversion rate and a selectivity of the catalysts prepared in the example 1 for a chlorinated aromatic compound in an oxidation reaction.

Specifically, the 0.5 g catalyst prepared in the example 1 was filled in the fixed-bed reactor and then subject to a reaction so as to examine reactivity thereof for a reaction time of 2 hours at an interval of 50° C. from 150° C. to 600° C., respectively. 1,2-dichlorobenzene was used as a reactant and maintained to be 1,000 ppm. A gas stream having an air composition of oxygen 20% and nitrogen 80% was maintained to be 50 ml/min. and a heater box was provided to prevent the reactant from being condensed in a tube connected to the reactor. A gas chromatography was used so as to establish a stoichiometry of carbons in the reactant and product. In particular, the carbon dioxide and carbon monoxide were measured in a ppm unit using a methanation apparatus.

A Table 1 shows conversion rates of 1,2-dichlorobenzene obtained from oxidation reaction experiments of the 3 wt % and 5 wt % vanadia-titania aerogel catalysts. The conversion rate is a value obtained by dividing an amount of 1,2-dichlorobenzene exhausted in the catalytic reaction by an amount of 1,2-dichlorobenzene before the reaction and then multiplying it by 100 for conversion into a percent unit.

TABLE 1

| Temperature | | |
|---|---|---|
| (° C.) | Conversion rate at 3 wt % | Conversion rate at 5 wt % |
| 150 | <5% | <5% |
| 200 | 20.8% | 33.2% |
| 250 | 63.3% | 80.3% |
| 300 | 81.1% | 93.9% |
| 350 | 90.5% | 98.4% |
| 400 | 95.9% | >99.5% |
| 450 | 98.5% | >99.5% |
| 500 | >99.5% | >99.5% |
| 550 | >99.5% | >99.5% |
| 600 | >99.5% | >99.5% |

As can be seen from the Table 1, as the reaction temperature was increased, an oxidative reactivity of 1,2-dichlorobenzene was increased, so that the 3 wt % vanadia-titania aerogel catalyst exhibited about 90% of conversion rate and the 5 wt % vanadia-titania aerogel catalyst exhibited about 98% of conversion rate at 350° C. All the selectivity for carbon oxide was 95% or more.

FIG. 4 is a graph comparing a conversion rate of a chlorinated material and a yield of carbon oxide obtained by oxidation-reacting a chlorinated aromatic compound using vanadia-titania aerogel catalysts prepared in the example 1. In FIG. 4, □ indicates 2 wt % vanadia-titania aerogel catalyst, ∘ indicates 5 wt % vanadia-titania aerogel catalyst and Δ indicates 10 wt % vanadia-titania aerogel catalyst.

In FIG. 4, the conversion rate of 1,2-dichlorobenzene and the yield of the carbon oxide show a linear relationship of about 1:1. Accordingly, it can be seen that the chlorinated material was well decomposed into the carbon oxide without a by product.

### Example 2

### Preparation of Vanadia-Titania Aerogel Catalyst (Non-Alkoxide was Used)

A solution was prepared so that a mole ratio of titanium (IV) tetrachloride (TiCl₄), water, propylene oxide, nitric acid and ethanol was 1:4:4:0.1:30, respectively. To the solution was added vanadium oxytrichloride (VOCl₃) to suit a weight percent. When gel was formed through a stirring for a predetermined time, the stirring was stopped and then the gel was matured at a room temperature. The subsequent supercritical drying and heat treatment processes were same as in the example 1.

In the example 2, non-alkoxide was used as the precursor of titanium oxide and vanadium oxide, rather than the alkoxide. However, the composition and form of vanadia-titania aerogel catalyst finally obtained were almost same or similar to the example 1. As a result, the conversion rate of the vanadia-titania aerogel catalyst prepared in the example 2 for the chlorinated aromatic compound in the oxidation reaction was almost similar to the example 1.

### Example 3

### Preparation of Vanadia-Titania Aerogel Catalyst (Manganese was Added)

A solution was prepared so that a mole ratio of titanium (IV) butoxide (Ti[O(CH₂)₃CH₃]₄), water, nitric acid and ethanol was 1:4:0.1:30, respectively. To the solution was added vanadium triisopropoxide oxide ([(CH₃)₂CHO]₃VO) and manganese nitrate (Mn(NO₃)₂) to be 2 wt % vanadia-3 wt % manganese-titania aerogel catalyst. When gel was formed through a stirring for a predetermined time, the stirring was stopped and then the gel was matured at a room temperature. The subsequent supercritical drying and heat treatment processes were same as in the example 1. The processes of measuring the conversion rate and the selectivity in accordance with the oxidation reaction were same as in the example 1.

A Table 2 shows a difference of production amounts of carbon oxides (carbon monoxide and carbon dioxide) produced when 1,2-dichlorobenzene was decomposed as a manganese oxide was added. At this time, the experiment result was based on 5 wt % activated oxide.

TABLE 2

| | 5 wt % vanadia-titania | | 2 wt % vanadia-3 wt % | |
|---|---|---|---|---|
| | aerogel | | manganese-titania aerogel | |
| Temperature | Carbon | Carbon | Carbon | Carbon |
| (° C.) | monoxide | dioxide | monoxide | dioxide |
| 150 | 9 | 31 | 0 | 0 |
| 200 | 133 | 332 | 4 | 13 |
| 250 | 488 | 997 | 40 | 62 |
| 300 | 1064 | 1817 | 137 | 213 |
| 350 | 1374 | 1950 | 532 | 767 |
| 400 | 1773 | 2349 | 1418 | 1950 |
| 450 | 2039 | 2793 | 2061 | 3023 |
| 500 | 2105 | 2881 | 1706 | 4091 |
| 550 | 2527 | 3945 | 434 | 5474 |
| 600 | 2172 | 3901 | 177 | 5718 |

As can be seen from the Table 2, when the manganese oxide was added, it was possible to increase the selectivity of the carbon dioxide up to 95% or more.

### Comparison Example 1

A reaction experiment was performed using commercial SCR (selective catalytic reduction) denitrification catalyst purchased under same conditions as the example 1. As an analysis result of the catalyst component, the commercial catalyst was vanadia/titania catalyst having 4.61 wt % of vanadia and a conversion rate of 1,2-dichlorobenzene during first reaction was 98% at 350° C. under same conditions of the reaction experiment as the example 1. However, the conversion rate was remarkably decreased: 80% at second reaction, 32% at third reaction and 17% at fourth reaction.

On the contrary, the conversion rate of the 5 wt % vanadia-titania aerogel catalyst of the invention was in remarkable contrast to the comparative example 1: 85% at first reaction, 98% at second reaction and 94% at third reaction.

### INDUSTRIAL APPLICABILITY

The vanadia-titania aerogle catalyst of the invention has the very high conversion rate and selectivity degree for the complete oxidation reaction of the chlorinated aromatic compound and is very thermally stable, it can be usefully used in the oxidation reaction having a high heating value capable of generating local heat spots. In particular, most of the chlorinated materials are generally incinerated. Accordingly, when the vanadia-titania aerogel catalyst of the invention is provided to a rear end of an incinerator, it is possible to maintain a proper temperature at which the catalyst can exhibit an activity thereof, so that it is efficient in cost reduction.

The vanadia-titania aerogel catalyst of the invention is not limited to the oxidation reaction of the chlorinated aromatic compound and can be also usefully used for a de-NOx reaction or ammoxidation reaction.

1. A vanadia-titania aerogel catalyst having an aerogel form dried by a supercritical drying method with a micro porosity structure being maintained and having many porosities and a wide specific surface area, and consisting of vanadia and titania, a content of the vanadia being 1˜15 wt % of an overall catalyst weight.

2. The catalyst according to claim 1, further containing a manganese oxide of 1˜5 wt %.

3. The catalyst according to claim 1, further containing a sulfur component of 0.0001˜1 wt %.

4. A method of preparing a vanadia-titania aerogel catalyst, the method comprising:
a first step of adding an acid catalyst to a solution of alkoxide or non-alkoxide inorganic gel raw material which is a precursor of a vanadium oxide and a titanium oxide and maintaining a temperature to be constant, thereby synthesizing gel;
a second step of maturing the gel prepared in the first step at constant temperature;
a third step of solvent-exchanging the gel matured in the second step using carbon dioxides and then drying it via a supercritical process; and
a fourth step of removing an organic material of the aerogel dried in the third step under inert atmosphere and then heat-treating the aerogel under air or oxygen atmosphere.

5. The method according to claim 4, wherein when the inorganic gel raw material in the first step is non-alkoxide, one or more epoxides selected from a group consisting of ethylene oxide, propylene oxide and butylene oxide is together used.

6. The method according to claim 4, wherein the acid catalyst in the first step is at least one selected from a group consisting of hydrochloric acid, nitric acid, acetic acid and oxalic acid.

7. The method according to claim 4, wherein at least one of a precursor of a manganese oxide and a sulfur component is further added to the inorganic gel raw material in the first step.

8. The method according to claim 7, wherein the precursor of the manganese oxide is manganese nitrate, manganese acetate or manganese hydrochloride.

9. The method according to claim 7, wherein the sulfur component is sulfuric acid or sulfate.

10. An oxidative decomposition method of a chlorinated aromatic compound wherein the chlorinated aromatic compound is subject to an oxidation reaction using the vanadia-titania aerogel catalyst according to claim 1.

11. An oxidative decomposition method of a chlorinated aromatic compound wherein the chlorinated aromatic compound is subject to an oxidation reaction using the vanadia-titania aerogel catalyst according to claim 2.

12. An oxidative decomposition method of a chlorinated aromatic compound wherein the chlorinated aromatic compound is subject to an oxidation reaction using the vanadia-titania aerogel catalyst according to claim 3.
